(19) United States
(12) Patent Application Publication
(10) Pub. No.: US 2021/0122924 A1
(43) Pub. Date: Apr. 29, 2021

(54) RESIN SHEET FOR MILLIMETER WAVE REFLECTION

(71) Applicant: PANASONIC INTELLECTUAL PROPERTY MANAGEMENT CO., LTD., Osaka (JP)

(72) Inventor: Tomohiro KUZUU, Tokyo (JP)

(73) Assignee: PANASONIC INTELLECTUAL PROPERTY MANAGEMENT CO., LTD., Osaka (JP)

(21) Appl. No.: 17/143,686

(22) Filed: Jan. 7, 2021

Related U.S. Application Data
(62) Division of application No. 16/333,710, filed on Mar. 15, 2019.

(30) Foreign Application Priority Data
Sep. 26, 2016 (JP) 2016-187601
Mar. 29, 2017 (JP) 2017-065911

(51) Int. Cl. C08L 101/00; C08K 3/22; G01S 7/03; H01Q 15/14

(52) U.S. Cl. CPC C08L 101/00; C08K 3/22; G01S 13/93; H01Q 15/14; G01S 7/03

(57) ABSTRACT

A resin sheet includes a resin composition for millimeter wave reflection which includes a dielectric filler and a resin. The resin sheet is a planar molded object of the resin composition, and has a first main surface and a second main surface that is opposite to the first main surface. At least one of the first main surface and the second main surface has an uneven structure configured to retro-reflect a millimeter wave.

### CROSS-REFERENCE TO RELATED APPLICATIONS

This application is a Divisional of U.S. patent application Ser. No. 16/333,710, filed on Mar. 15, 2019, which is a National Stage Entry of International Application No. PCT/JP2017/032762, filed Sep. 12, 2017, which claims priority to Japanese Patent Application No. 2017-065911, filed Mar. 29, 2017, and Japanese Patent Application No. 2016-187601, filed Sep. 26, 2016. The entire disclosure of each of the above-identified applications, including the specification, drawings, and claims, is incorporated by reference herein in its entirety.

### TECHNICAL FIELD

The present disclosure relates to a resin sheet for millimeter wave reflection.

### BACKGROUND

Recently, many vehicles have brake systems to lessen collision damage by sensing an obstacle nearby and avoiding a collision against this obstacle. Such brake systems, which lessen collision damage, have a sensor, known examples of which are millimeter wave radars, infrared radars, and cameras. Of these examples, millimeter wave radars are especially significant, because the millimeter wave radars tend to be unaffected by backlight, rain, or fog, for example, and thus are still effective in low-visibility situations, such as at night and in bad weather. A millimeter wave radar emits a millimeter wave and then receives the radio wave reflected by an obstacle, thereby measuring the position, relative velocity, direction, and other physical properties of the obstacle.

There has been a problem, however, that millimeter wave radars may fail to sense a passerby although capable of sensing a vehicle precisely. A reason is that a millimeter wave reflected by a vehicle is strong but a millimeter wave reflected by a passerby is weak.

Unexamined Japanese Patent Publication No. 2008-95236 discloses a T-shirt and a belt that helps a millimeter wave radar be able to sense a passerby. More specifically, the T-shirt has shoulder parts, the fabric of which is made of a synthetic fiber containing a metal powder such as an aluminum powder. The belt has many hollow, pyramidal corner reflectors, each of which is a reflection plate made of a metal such as iron.

### SUMMARY

A resin sheet includes a resin composition for millimeter wave reflection which includes a dielectric filler and a resin. The resin sheet is a planar molded object of the resin composition, and has a first main surface and a second main surface that is opposite to the first main surface. At least one of the first main surface and the second main surface has an uneven structure configured to retro-reflect a millimeter wave.

According to the present disclosure, it is possible to provide clothing and an article, without use of a metal having a low electrical resistivity, that can be both easily sensed by a millimeter wave radar.

### BRIEF DESCRIPTION OF DRAWINGS

FIG. 1A is a front view of a corner cube element.

FIG. 1B is a front view of a resin sheet having a corner cube type retroreflective structure.

FIG. 1C is a cross-sectional view of the resin sheet taken along line X-X in FIG. 1B.

FIG. 2A is a front view of a resin sheet having a hemispherical type retroreflective structure.

FIG. 2B is a cross-sectional view of the resin sheet taken along the line Y-Y in FIG. 2A.

FIG. 3 is a diagram illustrating a millimeter wave reflection property of a resin sheet according to Example with respect to a millimeter wave frequency.

### DESCRIPTION OF EMBODIMENT

Prior to description of an exemplary embodiment of the present disclosure, problems found in conventional techniques will briefly be described. The clothing described in Unexamined Japanese Patent Publication No. 2008-95236, for which a metal is used, exhibits a high reflection intensity for a millimeter wave but may have some practical problems, examples of which will be described below. If a person wearing the clothing for which a metal is used is outside during a shower of rain, for example, this person is at high risk of being struck by lightning. When the clothing is washed, this closing may be oxidized and thus deteriorate. The clothing may trigger a metal allergy.

The present disclosure provides a resin composition for millimeter wave reflection, a resin sheet, a fiber, and an article for millimeter wave reflection, all of which are easily sensed by a millimeter wave radar by using a high-dielectric metal oxide that has an electrical resistivity higher than an electrical resistivity of metals and that has little effect on a human body.

An exemplary embodiment of the present disclosure will be described below.

[Resin Composition for Millimeter Wave Reflection According to this Exemplary Embodiment]

A resin composition for millimeter wave reflection according to this exemplary embodiment (referred to below as a millimeter wave reflection resin composition) contains a dielectric filler and a resin. This millimeter wave reflection resin composition is sensed easily by a millimeter wave radar although a metal having a low electrical resistivity is not used. For example, if a passerby wears a molded object, as will be described later, of the millimeter wave reflection resin composition, this passerby is sensed easily by a millimeter wave radar provided in a vehicle. Consequently, using this molded object can reduce the risk of an occurrence of an accident in which a passerby and a vehicle make contact with each other. Furthermore, since no metals are used, the millimeter wave reflection resin composition is less likely to be oxidized and deteriorate even when washed, and a person who puts on the millimeter wave reflection resin composition is less likely to be struck by lightning and to develop a metal allergy. For these reasons, clothing for which the millimeter wave reflection resin composition according to this exemplary embodiment is used is superior in safety than conventional clothing for which a metal is used.

Herein, the word “millimeter wave” refers to the electromagnetic wave having a wavelength ranging from 1 mm to 10 mm both inclusive and a frequency ranging from 30 GHz to 300 GHz both inclusive. Actually, millimeter wave radars provided in vehicles typically use an electromagnetic wave having a frequency of 77 GHz or 79 GHz.

The millimeter wave reflection resin composition, if needed, may further contain a curing agent, an accelerator, an inorganic filler, a plasticizer, an antioxidant, a flame retardant, an antistatic agent, a pigment, a dye, and a light stabilizer.

### (Dielectric Filler)

The millimeter wave reflection resin composition contains the dielectric filler. This dielectric filler contributes to an increased intensity of a millimeter wave reflected from the millimeter wave reflection resin composition.

The dielectric filler, which differs from metal powders, is typically a material having an electrical resistivity higher than an electrical resistivity of metals such as aluminum.

Examples of the dielectric filler include a titanium oxide powder, a barium titanate powder, an iron oxide powder, and a strontium titanate powder. The metal elements contained in these oxides may be replaced with other metal elements. Specifically, the dielectric filler is more preferably at least one selected from a group consisting of a titanium oxide powder, a barium titanate powder, and an iron oxide powder. This dielectric filler contributes to a further increased intensity of a millimeter wave reflected from the millimeter wave reflection resin composition.

If the millimeter wave reflection resin composition contains at least a titanium oxide powder as the dielectric filler, the titanium oxide powder preferably has a white color. The titanium oxide powder having a white color produces an effect of easily reflecting light in addition to the millimeter wave.

The dielectric constant of the material of the dielectric filler is preferably in the range of 10 or more, more preferably in the range of 30 or more in the 77 GHz or 79 GHz band. When the dielectric constant falls within this range, the reflectance becomes 50% or more. In this case, for example, a millimeter wave radar can easily sense a passerby wearing a molded object of the millimeter wave reflection resin composition. Herein, the word “reflectance” refers to a ratio between an intensity of the millimeter wave reflected by the molded object of the millimeter wave reflection resin composition and an intensity of the millimeter wave incident on the molded object of the millimeter wave reflection resin composition.

The dielectric filler may have a spherical, planar, or needle-like shape, for example, although the shape is not limited to a specific one. Of these shapes, a spherical shape is most preferred, because the spherical shape facilitates the retroreflection. The sphericity of the dielectric filler is preferably in the range of 2.0 or less, more preferably in the range of 1.5 or less, and most preferably 1.0 (perfect sphere). The sphericity is a value obtained by dividing the maximum diameter by the minimum diameter. Herein, the word “retroreflection” refers to the reflection in which the reflection wave selectively returns in a direction substantially parallel to the propagation path of the incident wave.

The dielectric filler may be the combination of two or more materials having different shapes, sizes, or other geometric properties.

The content of the dielectric filler is preferably in the range of 40 mass % or more, more preferably in the range of 50 mass % or more with respect to the total mass of a solid content of the millimeter wave reflection resin composition. When the content of the dielectric filler falls within this range, this dielectric filler can contribute to a further increased intensity of a millimeter wave reflected from the millimeter wave reflection resin composition.

The dielectric filler may be subjected to a surface treatment with an appropriate surface treatment agent, for example, depending on the type of the resin. The surface treatment agent may be a silane coupling agent, for example.

### (Resin)

The millimeter wave reflection resin composition contains the resin. The dielectric constant of the resin in a frequency range from 30 GHz to 300 GHz both inclusive is preferably in the range from two to four both inclusive, more preferably in the range from three to four both inclusive. The resin that falls within this dielectric constant range can contribute to a further increased reflection intensity of a millimeter wave transmitted from a millimeter wave radar.

The resin may be adjusted as appropriate in accordance with a purpose of using the millimeter wave reflection resin composition or the molded object of the millimeter wave reflection resin composition. This resin may be either a thermoplastic resin or a thermosetting resin. Concrete examples of the resin include an olefin-based resin, a styrene resin, a vinyl chloride-based resin, polyester, a polycarbonate, an acrylonitrile-styrene copolymer resin (AS resin), polyacrylonitrile, a butadiene resin, an acrylonitrile butadiene styrene copolymer resin (ABS resin), an acrylic resin, polyacetal, polyphenylene ether, a phenol resin, an epoxy resin, a melamine resin, an urea resin, a polyimide, a polysulfide, a polyurethane, a vinyl acetate-based resin, a fluorine-based resin, aliphatic polyamide, a synthetic rubber, an aromatic polyamide, and a polyvinyl alcohol. Examples of the olefin-based resin include low-density polyethylene (LDPE), linear low-density polyethylene (LLDPE), high-density polyethylene (HDPE), and polypropylene. Examples of the polyester include polyethylene terephthalate (PET), polytrimethylene terephthalate, and polybutylene terephthalate. Examples of the aliphatic polyamide include nylon 6 and nylon 66. Examples of the synthetic rubber include an ethylene-propylene-(non-conjugated dienes) rubber, a polybutadiene rubber, a polyisoprene rubber, a styrene-butadiene rubber, and an acrylonitrile-butadiene rubber. Examples of the aromatic polyamide include polymetaphenylene isophthalamide and polyparaphenylene terephthalamide.

If the millimeter wave reflection resin composition is used as a fibrous molded object that will be described later, preferred examples of the resin include an olefin-based resin, a vinyl chloride-based resin, a fluorine-based resin, an acrylic resin, an aliphatic polyamide, polyester, aromatic polyamide, polyvinyl alcohol, and polyacrylonitrile.

A method of preparing the millimeter wave reflection resin composition may be, for example, a method in which predetermined quantities of the resin, the dielectric filler, and other components to be used as appropriate are prepared and combined in a solvent and further stirred and mixed. Examples of the solvent include ether such as ethylene glycol monomethyl ether, acetone, methyl ethyl ketone (MEK), dimethylformamide, benzene, and toluene. One of these solvents may be used singly, or two or more of the solvents may be used in combination.

[Resin Sheet According to this Exemplary Embodiment]

The resin sheet according to this exemplary embodiment (referred to below as the millimeter wave reflection resin sheet) may be a planar molded object of the millimeter wave reflection resin composition. More specifically, the millimeter wave reflection resin sheet may be manufactured by forming the millimeter wave reflection resin composition into a planar shape. The dielectric filler is embedded in the millimeter wave reflection resin composition.

The configuration of the millimeter wave reflection resin sheet is formed of one or more layers; the layers may include: a support body (base material); and a layer made of the millimeter wave reflection resin composition which is laminated on at least one surface of the support body. Examples of the base material include a base film and a touch fastener. Examples of the base film include a polyethylene terephthalate (PET) film, a polyolefin film, a polyacrylic film, and a polyvinyl chloride film. The touch fastener includes a male fastener and a female fastener. The male fastener has many small key-shaped hooks; the female fastener has a structure that engages with the corresponding hooks in the male fastener. Specific examples of the touch fastener include Magic Tape (registered trademark), Magic Fastener (registered trademark), Velcro (registered trademark), and a hook and loop tape. If the millimeter wave reflection resin sheet that includes a plurality of layers is used while bonded to clothing or a bicycle, for example, the millimeter wave reflection resin sheet is preferably used with the layers made of the millimeter wave reflection resin composition facing outwardly.

The millimeter wave reflection resin sheet has a first main surface and a second main surface; at least one of the first and second main surfaces preferably has an uneven structure that retro-reflects the millimeter wave. The resin having this structure can contribute to a further increased reflection intensity of a millimeter wave transmitted from a millimeter wave radar.

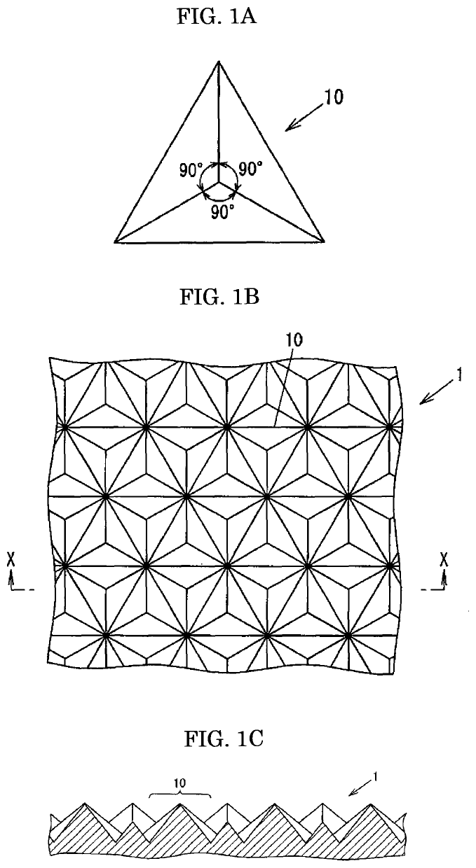

FIG. 1A is a front view of corner cube element 10. FIG. 1B is a front view of a resin sheet having a corner cube type retroreflective structure. FIG. 1C is a cross-sectional view of the resin sheet taken along line X-X in FIG. 1B.

The uneven structure that easily retro-reflects the millimeter wave is not limited to a specific structure. Examples include a corner cube type retroreflective structure and a hemispherical type retroreflective structure. For example, the size of the uneven structure may be adjusted as appropriate in accordance with a purpose of using the millimeter wave reflection resin sheet.

The corner cube type retroreflective structure is a structure in which a plurality of corner cube elements 10 illustrated in FIG. 1A are provided on at least one of the first and second main surfaces of millimeter wave reflection resin sheet 1. One example of the corner cube type retroreflective structure may be a structure in which corner cube elements 10 are formed most densely as illustrated in FIGS. 1A and 1B. Corner cube element 10 has a recessed shape with thee planes perpendicular to one another.

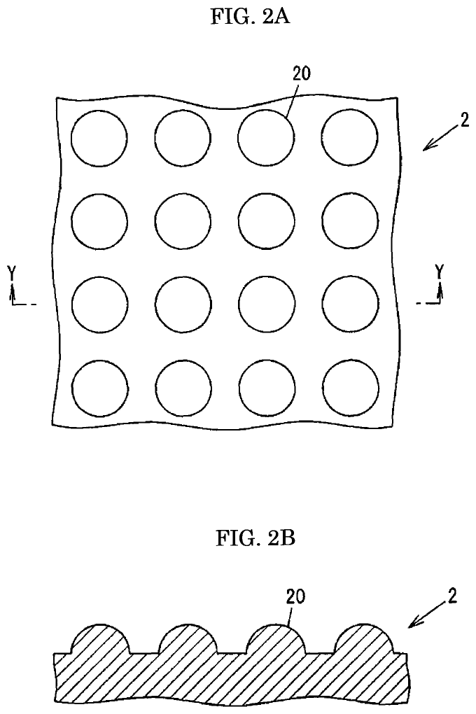

The hemispherical type retroreflective structure is a structure in which a plurality of hemispherical elements 20 are provided on at least one of the first and second main surfaces of millimeter wave reflection resin sheet 2 as illustrated in FIG. 2B. One example of the hemispherical type retroreflective structure may be a structure in which hemispherical elements 20 are formed in a square lattice fashion as illustrated in FIGS. 2A and 2B. The cross-sectional shape of each hemispherical element 20 may be adjusted as appropriate in accordance with a purpose of using the millimeter wave reflection resin sheet. Examples include a semicircle shape, a semi-ellipse shape, a triangle shape, a rectangle shape, a rhombus shape, and a hexagon shape.

The millimeter wave reflection resin sheet may be processed so as to be usable appropriately as a road safety product. More specifically, the millimeter wave reflection resin sheet may be used appropriately as a school bag cover, a raincoat, an umbrella fabric, boots, a reflection button, a key chain, a wristband, a curled wristband, a sash, a bag, a carrier-bag, a reflection tape, a bicycle spoke light, a safety vest, an armband, and a hat cover, for example. This road safety product, when worn by a passerby, can further reduce the risk of an occurrence of an accident in which the passerby and a vehicle make contact with each other. Especially when worn by a child, this road safety product can protect the child from cars even while an adult fails to see the child.

A method of manufacturing the millimeter wave reflection resin sheet may be adjusted as appropriate in accordance with a purpose of using the millimeter wave reflection resin sheet. Examples include melt extrusion molding and injection molding.

[Fiber According to this Exemplary Embodiment]

A fiber according to this exemplary embodiment (referred to below as a millimeter wave reflection fiber) is a fibrous molded object of the millimeter wave reflection resin composition. This millimeter wave reflection fiber is manufactured by forming the millimeter wave reflection resin composition into a fibrous form, and the dielectric filler is embedded in the millimeter wave reflection fiber. Even if a fabric manufactured from the millimeter wave reflection fiber is washed, for example, the dielectric filler is less likely to be removed from the millimeter wave reflection fiber.

The fibrous molded object has a geometry in which the diameter is 1 nm or more and a ratio (aspect ratio) of the length to the diameter is 100 or more. The fibrous molded object may be either long or short fibers. For example, the short fibers may be obtained by cutting resultant long fibers into a necessary length.

A method of manufacturing the millimeter wave reflection fiber may be selected and adjusted as appropriate in accordance with a resin to be used for the manufacturing. Examples include: a method of introducing a pellet-formed material manufactured through the polymerization of the millimeter wave reflection resin composition into an extruder, applying heat to the material, pressing the molten material, and then cooling the material in the air to solidify the material; and a method of molding a liquid mixture, which is the millimeter wave reflection resin composition, into fibers with a wet or dry spinning method and removing the solvent. In addition, the resultant millimeter wave reflection fiber may be subjected to some after-treatments, such as drawing and a heat treatment. These after-treatments can be effective in improving mechanical and other properties of the millimeter wave reflection fiber.

The millimeter wave reflection fiber is used appropriately for a raw material of a millimeter wave reflection yarn by which a fiber production for millimeter wave reflection is woven. The millimeter wave reflection yarn may be a long, linear form of millimeter wave reflection fiber. Examples include a filament yarn, a spun yarn, a blended yarn, a bulked yarn, a texturized yarn, a composite yarn, a hollow yarn, a core-spun yarn, a long and short composite yarn, a commingled yarn, a knitted and weaved yarn, and a fancy yarn. If the millimeter wave reflection yarn is a composite yarn, this composite yarn may contain a standard fiber. Examples of the standard fiber include a polyolefin fiber, a polyamide fiber, a polyvinyl alcohol fiber, a polyacrylonitrile fiber, a polyester fiber, a polyvinyl chloride-based fiber, an acrylic fiber, and a polyurethane fiber. The combined ratio between the millimeter wave reflection fiber and the standard fiber may be any ratio that falls outside a range that may degrade the effect of the present disclosure.

Examples of the fabric structure of the fiber product for millimeter wave reflection include a textile, a knit, a braid, a lace, a net, and a nonwoven fabric. Examples of the weave of the textile include a plain weave, a twill weave, and a sateen weave. Examples of the weave of the knit include plain (stitch) knitting, rib knitting, double knitting, half knitting, power net knitting, raschel knitting, and multi-axial knitting. Examples of the braid include a flat braid, a tubular braid, and a square braid. Examples of the lace include a leaver lace, a raschel lace, a torchon lace, an embroidery lace, and a multi-head embroidery lace. Examples of the net include a knotted net, a non-knotted net, and a raschel net.

Specific examples of the fiber product for the millimeter wave reflection include a shirt, slacks, pants, a skirt, a undershirt, a house dress, a Japanese summer kimono, a jumper, a vest, a coat, a sweater, a jacket, a blazer, a dress, a cardigan, a racing suit, a school children's clothing, a school uniform, a towel or similar cloth, a handkerchief or similar cloth, a scarf, insoles, socks, a underwear, a medium wear, an outer wear, an outer fabric of clothes, an inner fabric of clothes, a hat, gloves, a muffler, an ear warmer, tights, a belly band, a side fabric of shoes, a dress belt, and a supporter. This fiber product for millimeter wave reflection, when worn by a passerby, can further reduce the risk of an occurrence of an accident in which the passerby and a vehicle make contact with each other. Especially when worn by a child, this fiber product for millimeter wave reflection can protect the child from cars even while an adult fails to see the child.

[Article for Millimeter Wave Reflection According to this Exemplary Embodiment]

The article for millimeter wave reflection according to this exemplary embodiment (referred to below as the millimeter wave reflection article) includes: a base material; and a cover film made of the millimeter wave reflection resin composition. The cover film is attached to a surface of the base material. This millimeter wave reflection article, when worn by a passerby, can further reduce the risk of an occurrence of an accident in which the passerby and a vehicle make contact with each other. Especially when worn by a child, this millimeter wave reflection article can protect the child from cars even while an adult fails to see the child.

When a road-worker wears clothing provided with the above millimeter wave reflection article, the road-worker can be easily sensed with the millimeter wave even under a condition of low eyes' or camera's visibility, such as at night or in bad weather. This millimeter wave reflection article can therefore contribute to a reduced risk of an occurrence of a minor accident.

The base material is preferably a product that a passerby puts on his/her body. Examples include a surrounding article, a sundry article, a fiber, a yarn, and a fiber product. Examples of the surrounding article include a school bag, a raincoat, boots, shoes, a leather belt, a wallet, a leather pouch, an umbrella, a reflection button, a key chain, a wristband, a curled wristband, a sash, a bag, a carrier-bag, a reflection tape, a safety vest, an armband, a hat, a bicycle, a tricycle, and a unicycle. Examples of the sundry article include glasses, a watch, a precious metal, a jewel, a sport gear, a stationery product, a book, and a toy. Examples of the fiber product include a shirt, slacks, pants, a skirt, an undershirt, a house dress, a Japanese summer kimono, a jumper, a vest, a coat, a sweater, a jacket, a blazer, a dress, a cardigan, a racing suit, school children's clothing, a school uniform, a towel or similar cloth, a handkerchief or similar cloth, a scarf, insoles, socks, an underwear, a medium wear, an outer wear, an outer fabric of clothes, an inner fabric of clothes, gloves, a muffler, an ear warmer, tights, a belly band, side fabrics of shoes, a dress belt, and a supporter.

The millimeter wave reflection resin composition may be used, as one application, for a pavement marking member, such as a white or yellow line. The pavement marking member for which the millimeter wave reflection resin composition is used greatly reflects the millimeter wave from a car, thereby advantageously causing the driver to recognize a white line even if the natural environment, such as snow, hinders the visual perception of the white line. The millimeter wave reflection resin composition may be added to a pavement marking member, or may be added to an adhesive material to be interposed between an asphalt road and the pavement marking material. Alternatively, the millimeter wave reflection resin sheet may be used while boned to a planar pavement marking member.

The millimeter wave reflection article may be an existing product around which the millimeter wave reflection resin sheet is looped. As an example, the millimeter wave reflection resin sheet may be looped around a road safety product, such as a road cone, in order to provide the road safety product with a reflection property. As a result, this road safety product acts as an object to be sensed by a millimeter wave radar sensor upon an accident or emergency, thereby enhancing safety for accidental measures.

A method of manufacturing the millimeter wave reflection article may be, for example, a method of applying the millimeter wave reflection resin composition to the base material and curing the resin. Examples of the method of applying the millimeter wave reflection resin composition to the base material include spray coating and dip coating. Examples of the method of curing the resin include heating and light irradiation, for example, that may be adjusted as appropriate in accordance with a material of the resin. The millimeter wave reflection resin composition can be used to easily intensify the reflection of the millimeter wave from the existing product even if the base material is an existing product.

### EXAMPLE

Samples (millimeter wave reflection resin sheets) of PET films to which the resin composition was bonded were formed; materials of the samples and the manufacturing method used will be described below. Then, the millimeter wave reflection properties of these samples were measured. In Example, TiO₂ particles were used as the dielectric filler, an epoxy-containing acrylic resin was used as the resin, and the PET film was used as the base material. However, the scope of the present disclosure is not limited to these materials.

### (Material)

TiO₂ particles (produced by ISHIHARA SANGYO KAISHA, LTD. [product number CR-EL]) having a diameter of 0.314 μm (median)
Epoxy-containing acrylic resin
PET films (produced by TOYOBO CO., LTD. [product number TN100]) having a thickness of 100 μm

### (Manufacturing Method)

The viscosity of the mixture of 40 vol % of TiO₂ and the epoxy-containing acrylic resin was adjusted with ethyl methyl ketone (MEK), and then the resultant mixture was kneaded with a disper to produce a composite material. Then, the composite material was applied to the PET films and cured. In this case, the thicknesses of the composite material applied to the PET films were set differently, so that the resin composition-bonded PET films (millimeter wave reflection resin sheets) to which the resin compositions, or the cured composite materials, having thicknesses of 200 μm, 300 μm, and 600 μm were bonded were manufactured.

### (Measurement)

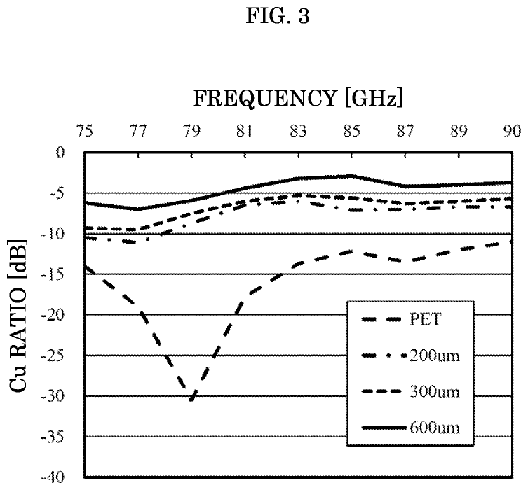

A transmission antenna was disposed at an angle of +5 degrees with respect to the normal to the surfaces of the millimeter wave reflection resin sheets (the thicknesses of the resin compositions were 200 μm, 300 μm, and 600 μm), which were manufactured in the above manner. A reception antenna was disposed at an angle of −5 degrees with respect to the normal to the surfaces of the millimeter wave reflection resin sheets. The transmission antenna emitted a millimeter wave at a frequency varying in the range from 75 GHz to 90 GHz both inclusive, and then the power of the millimeter wave received by the reception antenna was measured. The measurement result shows a ratio (Cu ratio) of the millimeter wave reflection loss of each millimeter wave reflection resin sheet with respect to the reflection loss of copper (Cu). Table 1 shows the average of the Cu ratios of each sample (at respective frequencies within the range from 77 GHz to 81 GHz) when the millimeter wave is incident on the surface of each sample at an angle of 5 degrees (with respect to the normal to the surface of each PET film). The samples are the PET films with the resin compositions having thicknesses of 200 μm, 300 μm, and 600 μm and a PET film alone. Furthermore, Table 1 shows the value of the electrical resistivity of each film as a reference value. FIG. 3 illustrates the property of the Cu ratio of each sample over the frequency range of the millimeter wave when the millimeter waves are incident at an angle of 5 degrees. The samples are the PET films with the resin compositions having thicknesses of 200 μm, 300 μm, and 600 μm and the PET film alone.

TABLE 1

| | | Cu RATIO (ON AVERAGE | |
|---|---|---|---|
| | | IN RANGE FROM 77 GHz | |
| | THICK- | TO 81 GHz) [dB] | |
| | NESS | INCIDENT ANGLE: 5 | ELECTRICAL RE- |
| SAMPLE | (μm) | DEGREES | SISTIVITY [Ωm] |
| Cu | — | 0 | 1.68 × 10⁻⁸ |
| TiO₂ + | 200 | −8.8 | 10¹²< |
| RESIN | 300 | −7.7 | 10¹²< |
| | 600 | −5.8 | 10¹²< |
| PET | — | −22.4 | 10¹²< |
| ALONE | | | |

### (Consideration)

Table 1 shows that each millimeter wave reflection resin sheet according to Example has an electrical resistivity (1.0×10¹² Ωm or more) substantially the same as an electrical resistivity of an insulating material such as a PET film but exhibits a reflectance much higher than a reflectance of the PET film. A millimeter wave reflection resin sheet having a greater thickness exhibits a higher millimeter wave reflectance. The millimeter wave reflection resin sheet with the resin composition having a thickness of 600 μm exhibits a millimeter wave reflectance (Cu ratio) of about −6 dB on the average over the range from 77 GHz to 81 GHz. Moreover, FIG. 3 illustrates that a resin composition having a greater thickness exhibits a higher millimeter wave reflectance (Cu ratio) at all frequencies within the range from 75 GHz to 90 Hz of the millimeter wave.

Example described above demonstrates that a resin containing a dielectric filler can be used to provide a molded object that has a millimeter wave reflectance much higher than a millimeter wave reflectance of a base material alone.

What is claimed is:

1. A resin sheet comprising a resin composition for millimeter wave reflection, the resin composition including a dielectric filler and a resin,
wherein:
the resin sheet is a planar molded object of the resin composition, the resin sheet having a first main surface and a second main surface that is opposite to the first main surface, and
at least one of the first main surface and the second main surface has an uneven structure configured to retro-reflect a millimeter wave.

2. The resin sheet according to claim 1, wherein the uneven structure is a structure that a plurality of corner cube elements are disposed on the at least one of the first main surface and the second main surface.

3. The resin sheet according to claim 2, wherein the plurality of corner cube elements are formed in a close-packed arrangement.

4. The resin sheet according to claim 1, wherein the uneven structure is a structure that a plurality of hemispherical elements are disposed on the at least one of the first main surface and the second main surface.

5. The resin sheet according to claim 4, wherein the plurality of hemispherical elements are formed in a square lattice arrangement.

6. The resin sheet according to claim 4, wherein a cross-section of each of the plurality of hemispherical elements has at least one shape selected from the group consisting of a semicircle shape, a semi-ellipse shape, a triangle shape, a rectangle shape, a rhombus shape, and a hexagon shape.

7. The resin sheet according to claim 1, wherein a content proportion of the dielectric filler in a total of solid component of the resin composition is 40 mass % or more.

8. The resin sheet according to claim 1, wherein a sphericity of the dielectric filer is 2.0 or less.

9. The resin sheet according to claim 1, wherein the dielectric filler includes at least one selected from the group consisting of a titanium oxide powder, a barium titanate powder, and an iron oxide powder.

10. The resin sheet according to claim 1, wherein:
the dielectric filler includes at least a titanium oxide powder, and
the titanium oxide powder has a white color.
